(19) United States
(12) Patent Application Publication
(10) Pub. No.: US 2012/0214369 A1
(43) Pub. Date: Aug. 23, 2012

(54) WATER CRAFT

(75) Inventors: Andre Knaack, Bad Abbach (DE); Gerhard Jetzorreck, Brennberg (DE)

(73) Assignee: HOERBIGER AUTOMATISIERUNGSTECHNIK HOLDING GMBH, Altenstadt (DE)

(21) Appl. No.: 13/457,351

(22) Filed: Apr. 26, 2012

Related U.S. Application Data
(63) Continuation of application No. PCT/EP2010/006521, filed on Oct. 26, 2010.

(30) Foreign Application Priority Data
Oct. 30, 2009 (DE) 10 2009 051 410.4

(51) Int. Cl. B63H 5/125; B66D 1/08; B63H 25/42; B63H 25/22

(52) U.S. Cl. 440/61 S; 440/61 D

(57) ABSTRACT

In a water craft having at least one hull and at least one drive motor, which has an operative drive connection via a drive train to a drive head comprising a propulsion means, the drive head is laterally pivotably mounted relative to the hull with respect to a steering axis. For the lateral adjustment of the drive head relative to the hull, at least one hydraulic steering cylinder is provided, which can be acted on by a hydraulic steering system comprising a hydraulic pump. A hydraulic system, which comprises a separate hydraulic unit and is intended to be used to act on a hydraulic load not serving to steer the water craft, can be coupled to the hydraulic steering system in order to effect an emergency steering function in the sense of acting on the hydraulic steering cylinder.

### CROSS-REFERENCE TO RELATED APPLICATIONS

The present application is a continuation of International Application No. PCT/EP2010/006521 filed on Oct. 26, 2010, which claims priority to German Application No. 10 2009 051 410.4, filed on Oct. 30, 2009, the contents of each of which are incorporated herein by reference.

### FIELD OF THE INVENTION

The present invention relates to a water craft with at least one hull and at least one drive motor, which has an operative drive connection via a drive train to a drive head comprising a propulsion means, wherein the drive head is mounted to pivot laterally relative to the hull around a steering axis and at least one hydraulic steering cylinder, which can be acted on by a hydraulic steering system comprising a hydraulic pump, is provided for lateral adjustment of the drive head relative to the hull.

### BACKGROUND

For motor boats, motor yachts and other motor-powered water craft, various drive concepts are known that differ, for example, with regard to the position of the motor relative to the hull (outboard motor, inboard motor). Among water craft with inboard motors, further distinctions can be made on the basis of type, design and mode of operation, position and arrangement of the propulsion means (for example, z-drive, gondola drive, surface drive and the like), wherein the drive head in each case is mounted to pivot laterally relative to the hull around a steering axis, in contrast to the situation for ships with shaft systems and conventional rudders. The water craft is steered by means of the steering device, which changes the position of the drive head.

Hydraulic steering systems are widely used for this purpose.

A water craft of the type mentioned in the introduction with a hydraulic steering system is known, for example, from U.S. Pat. No. 5,549,493 A. In this water craft a combined hydraulic steering and trimming system is provided. This comprises two hydraulic pumps connected to one another in parallel, which presumably, for lack of further information, are driven in conventional manner by the drive motor of the water craft, two hydraulic steering cylinders, two hydraulic trimming cylinders and one network of lines connecting the four hydraulic cylinders with the two hydraulic pumps and containing diverse control valves. By virtue of the pairwise double arrangement of hydraulic pumps, steering cylinders and trimming cylinders, multiple redundancy is achieved within the hydraulic steering and trimming system, so that the water craft remains maneuverable even in case of failure of one hydraulic pump, one steering cylinder and/or one trimming cylinder.

Hydraulic steering systems such as that according to U.S. Pat. No. 5,549,493 A are characterized by greater flexibility of the basic design of the respective water craft than is the case in mechanical steering systems (especially cable steering). In particular, motor boats and motor yachts can be equipped with several cockpits without notable expense and without complications.

Heretofore purely hydraulic steering systems have been widely used, the steering wheel being respectively in communication with a hydraulic pump (known as the helm pump), wherein the hydraulic fluid delivered by the helm pump—after passing through appropriate hydraulic lines to the hydraulic steering cylinder—acts directly on the steering cylinder and positions it corresponding to how the steering wheel is turned. More recently, steer-by-wire steering concepts, in which steering signals are generated in an electronic steering wheel, have become increasingly adopted specifically in the upper price range of motor yachts. The steering signals are further processed in downstream electronic as well as mechanical, electrical and/or hydraulic components of the steering system, for the purpose of adjusting the drive head. Whereas purely electrical steering systems, for example, can be contemplated in principle for steer-by-wire steering concepts, the great majority of motor boats having a steer-by-wire steering concept are equipped with electrohydraulic steering systems, in which the drive head is adjusted by means of a hydraulic steering cylinder, which is acted on by a hydraulic steering system, which in turn comprises a motor-driven hydraulic pump and adjustable control valves. In typical water craft of this type, the said hydraulic pump is driven directly by appropriate belts of the drive motor of the water craft (see above). In other known water craft of the class in question, the hydraulic pump of the hydraulic steering system is driven by a separate drive motor, designed in particular as an electric motor, so that the said hydraulic pump is part of an independent hydraulic power unit.

### SUMMARY

The object of the present invention is to increase the safety of water craft of the class in question, especially when they are equipped with a steer-by-wire steering concept, or in other words to reduce the risk of an accident due to failure of the steering system and/or to minimize the consequences of such a failure.

In a water craft of the type of the class in question as indicated in the introduction, the foregoing object is achieved according to the invention by a hydraulic system, which comprises a separate hydraulic power unit designed to act on a hydraulic power consuming load that is not intended to steer the water craft, and which can be coupled with the hydraulic steering system in the sense of acting on the steering cylinder. In other words, in the inventive water craft, it is possible to couple an independent hydraulic system, which by design has nothing to do with the steering in normal operation, in active hydraulic communication with the hydraulic steering system, by opening standby connections, which in normal operation of the water craft are blocked, with the result that the hydraulic steering cylinder can be acted on in emergency operation—corresponding to failure of essential components of the hydraulic steering system—by means of hydraulic energy supplied by the separate hydraulic power unit. Depending on the individual water craft, which is constructed according to the present invention, different hydraulic systems can be contemplated as suitable further hydraulic systems that can be called upon within the meaning of the present invention for the emergency steering function depicted in the foregoing. Particularly conceivable in this context is trimming of the water craft, or in other words the actuation of a separate hydraulic system acting as a trimming device. This is particularly favorable in typical application situations in which the trimming system is arranged in close physical proximity to the steering system. Of course, several other separate hydraulic systems can also be used, such as, for example, hydraulic systems acting to operate a winch, a shifting clutch or the like.

In this way the present invention purposefully and consciously avoids the repeatedly proposed approach (see JP 2004-001640 A, U.S. Pat. No. 4,836,810 A, U.S. Pat. No. 6,416,370 B1) of relying on a single hydraulic power unit both for acting on the at least one steering cylinder and at least one further hydraulic power consuming load (especially at least one hydraulic trimming cylinder). Instead, as outlined hereinabove and explained in greater detail hereinafter, in an inventive water vehicle—in express renunciation of the designs according to the prior art mentioned hereinabove—certainly at least one (separate) hydraulic system comprising a separate hydraulic power unit that when functioning as designed has no kind of connection to the steering system of the water craft can be coupled with the hydraulic steering system in emergency situations, by opening connections that are closed in normal operation (see above). In this way, by starting up the emergency steering provided hereby, steering of the water craft is maintained even in case of failure of the hydraulic steering system or essential components thereof, so that a return to the or to a harbor under its own power is possible even in this case.

A first preferred improvement of the inventive water craft is characterized in that the (separate) hydraulic system can be coupled with the hydraulic steering system via emergency valves, so that the connections between the two hydraulic systems, which as already explained hereinabove are closed in normal operation, are now opened by means of the said emergency valves. These emergency valves may in particular be operated manually, mechanically or else, for example, electrically, if they are designed as solenoid valves. Particularly preferably, an actuating switch for activation of the “emergency steering” and marked as such is provided on the dashboard of the or of a cockpit, so that the said emergency valves can be operated by actuation thereof. Specifically when the at least one hydraulic power consuming load, whose actuation is used for the (separate) hydraulic system in normal operation of the water craft in question, is not absolutely necessary for emergency operation thereof, as is typically the case for a trimming device, it may be provided that the said hydraulic power consuming load can be decoupled from the (separate) hydraulic system by means of the emergency valves, when the associated hydraulic power unit is coupled with the hydraulic steering system by actuation of the emergency valves. In this case the separate hydraulic power unit in question is available exclusively for emergency steering during emergency operation; thus a conflict with the function that it performs in normal operation is ruled out.

As an alternative to the automatic decoupling of the separate hydraulic power unit from the associated hydraulic power consuming load as described in the foregoing, it is possible for the hydraulic system to have switching valves, especially manually actuatable switching valves, for influencing the action on the associated hydraulic power consuming load. In an emergency, these may be switched in such a way that actuation of the hydraulic power consuming load by the separate hydraulic power unit is suppressed, whereby the latter is available completely and exclusively for emergency actuation of the steering cylinder.

In the interest of increased safety of the inventive water craft, it may be further advantageous, depending on the design of the hydraulic steering system, for the hydraulic steering system to be switchable into a floating position and/or for the mechanical coupling of the drive head with the hydraulic steering cylinder to be detachable. In this way it can be ensured that the adjustment of the drive head for the purpose of steering the water craft during emergency operation is possible manually if necessary, even if components of the hydraulic steering system are blocked.

According to yet another preferred improvement of the inventive water craft, the hydraulic pump of the hydraulic steering system is part of a steering hydraulic power unit, or in other words of an independent hydraulic power unit comprising the drive motor that alone serves to drive the hydraulic pump of the hydraulic steering system, wherein the drive motor is constructed in particular in the form of an electric motor. In this case, after all, the particularly advantageous structural option is available that the steering hydraulic power unit and the (separate) hydraulic power unit, which can be called upon for emergency steering, form a (single) subassembly. In this sense the hydraulic pump of the hydraulic steering system and the hydraulic pump of the hydraulic system comprising the separate hydraulic power unit can be mounted in or on a common pump block and/or the said subassembly can comprise a common connection block. This in turn opens up the possibility that an emergency valve unit in the sense explained hereinabove, by means of which the (separate) hydraulic power unit can be coupled with the hydraulic steering system, can be mounted integrally in the connection block and/or the pump block. In this case no separate connecting lines are needed, which is particularly favorable from viewpoints of safety and reliability as well as from viewpoints of assembly as well as maintenance. In turn, it is particularly advantageous when the steering hydraulic power unit and the separate hydraulic power unit—according to yet another improvement of the invention—can be supplied from a single, common hydraulic tank. This is extremely advantageous from viewpoints of operating safety. Specifically, the motors of the steering hydraulic power unit and of the hydraulic power unit can be arranged adjacent to one another on one side of a connection and/or pump block, while the common hydraulic tank is disposed on the other side of the connection and/or pump block in question. A particularly favorable option of the improvement that opens up hereby for the inventive water craft consists in mounting the hydraulic tank outboard, while the other components of the hydraulic systems are arranged inside the hull.

Within the meaning of the steer-by-wire steering designs already explained hereinabove, yet another preferred improvement of the inventive water craft is characterized in that the hydraulic steering system comprises electrically activated control valves, on which transducers connected to a steering device act, the said transducers being connected via control lines with the at least one control valve, in which case the steering device can be constructed in particular as an electronic steering wheel. Alternatively, the hydraulic steering system can be equipped with a hydraulic power unit, whose electric motor is reversible and is designed to be controlled by a control unit acted on by an electronic steering wheel. In addition to the inventive option of providing emergency steering in case of failure of the hydraulic steering system, at least one of the electronic steering wheels—distributed among several cockpits—of the water craft in question can form, together with an additional conventional helm pump, a combined electronic/hydraulic steering wheel that can be coupled with the hydraulic steering system. In this case a multi-level emergency steering system would be on standby in the sense that, in case of failure of the steer-by-wire steering, firstly the conventional steering system could be started up but, if it were also to fail, the inventive emergency steering system could be activated as the second level.

Merely for completeness, which in any case is clear from the foregoing explanations, is it pointed out that the present invention can be used equally well for water craft with the different drive concepts. For example, the drive head may comprise at least one propeller mounted to turn around an axis of rotation and/or the drive motor can be designed as an internal combustion engine, in which case the motor could be designed in particular as an outboard motor or else as an inboard motor supplying power to a z-drive.

The present invention will be explained in more detail hereinafter on the basis of a particularly preferred exemplary embodiment illustrated in the drawing, wherein

### BRIEF DESCRIPTION OF THE DRAWINGS

FIG. 1 shows, in a schematic view from above, an exemplary embodiment designed as a recreational motor boat for a water craft according to the present invention,

FIG. 2 shows a hydraulic circuit diagram for the recreational motor boat illustrated in FIG. 1,

FIG. 3 shows a side view of a subassembly comprising two hydraulic pumps used in a recreational motor boat according to FIG. 1,

FIG. 4 shows a view from above and from the motor side of the subassembly according to FIG. 3, wherein the electric motor of the steering hydraulic power units is merely indicated for reasons of illustration, and

FIG. 5 shows a hydraulic circuit diagram of a second exemplary embodiment of a water craft according to the present invention.

### DETAILED DESCRIPTION

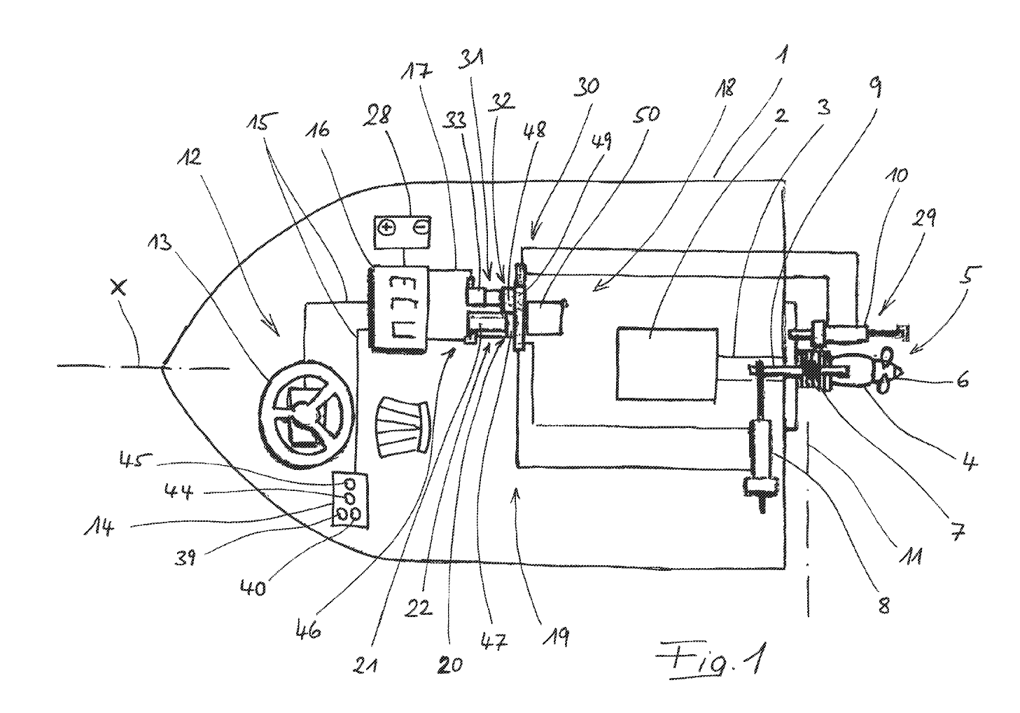

The water craft with z-drive shown in FIG. 1 comprises a hull 1 and a drive motor 2. This acts via a drive train 3 on a drive head 4, which comprises a propulsion means 5 in the form of a propeller 6. Relative to hull 1, drive head 4 is mounted to pivot laterally around a steering axis 7. For lateral adjustment of drive head 4 relative to hull 1, there is provided a hydraulic steering cylinder 8, which acts via a steering column 9 on drive head 4. By means of a trimming cylinder 10, drive head 4 can also be adjusted around a horizontal pivoting axis 11 (transverse axis) running perpendicular to the longitudinal axis X of the boat. Since the illustrated recreational motor boat corresponds to this extent to the adequately known prior art, further explanations are superfluous.

In the region of cockpit 12 of the recreational motor boat, a steering wheel 13 and a dashboard 14 are disposed as control elements. Both steering wheel 13 and dashboard 14 forming the steering device are connected via control lines 15 to control unit 16.

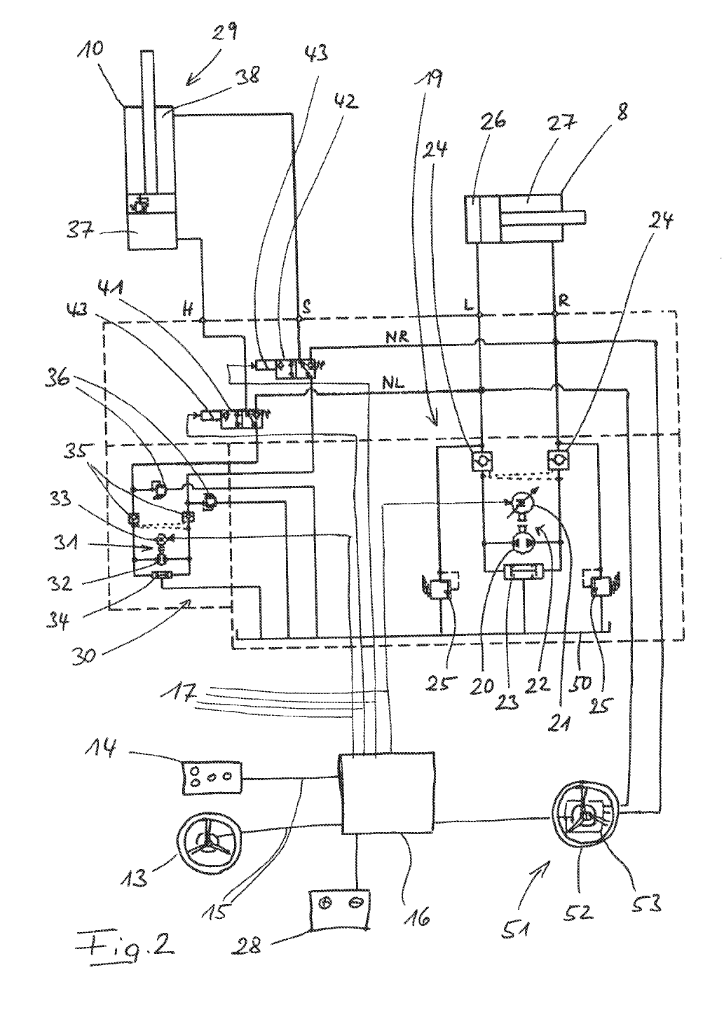

In control unit 16, the input signals generated by (electronic) steering wheel 13 and dashboard 14 are converted into output signals, which are transmitted via signal lines 17 to hydraulic group 18. Hydraulic group 18 comprises a hydraulic steering system 19, which is provided to act on hydraulic steering cylinder 8 and which in turn comprises a hydraulic pump 20, which is driven by a (reversible) electric motor 21 and thus is part of a steering hydraulic power unit 22. The hydraulic steering system also includes (see FIG. 2), as is known as such, especially a shuttle valve 23, two unlockable check valves 24 and two pressure-limiting valves 25. Via the ports L and R, hydraulic steering system 19 is in communication with the two working chambers 26 and 27 of hydraulic steering cylinder 8. Electric motor 21 of steering hydraulic power unit 22, supplied by battery 28 of the on-board electrical system, is controlled in normal operation of the recreational motor boat by turning steering wheel 13.

Trimming cylinder 10 represents a hydraulic power consuming load 29 that does not serve for steering of the recreational motor boat. It is acted on by a further hydraulic system 30, which is different from hydraulic steering system 19 and which comprises a separate hydraulic power unit 31. In turn, separate hydraulic power unit 31 comprises a hydraulic pump 32, which is driven by a (reversible) electric motor 33. Hydraulic system 30, which is designed to act on hydraulic power consuming load 29, also includes in particular a shuttle valve 34, two unlockable check valves 35 and two pressure-limiting valves 36. Via the ports H and S, hydraulic system 30 is in communication with the two working chambers 37 and 38 of hydraulic trimming cylinder 10. Electric motor 33 of separate hydraulic power unit 31, supplied by battery 28 of the on-board electrical system, is controlled in normal operation of the recreational motor boat by actuating knobs 39 (raise) and 40 (lower) disposed on dashboard 14.

In order to provide an emergency steering function, by the use of which the recreational motor boat can still be steered even in case of failure of steering wheel 13, of the signal processing that takes place downstream therefrom in control unit 16 and/or of components of hydraulic steering system 19, further hydraulic system 30 can be coupled with hydraulic steering system 19 in the sense of acting on hydraulic steering cylinder 8. For this purpose port H of hydraulic system 30 is associated with a first emergency valve 41 and port S of hydraulic system 30 is associated with a second emergency valve 42. Each of the two emergency valves 41 and 42 is constructed in such a way as a 3/2-way valve that, in normal operation, or in other words during non-energized condition of the respective solenoid 43, hydraulic system 30 acts on trimming cylinder 10. In emergency steering operation, however, solenoids 43 of the two emergency valves 41 and 42 are energized, which allows hydraulic system 30 to be coupled via emergency valves 41 and 42 with hydraulic steering system 19, while at the same time hydraulic power consuming load 29 (trimming cylinder 10) is decoupled by means of the emergency valves from hydraulic system 30.

In order to control the recreational motor boat in emergency steering operation, two emergency steering knobs, namely a first emergency steering knob 44 and a second emergency steering knob 45, are provided on dashboard 14. Actuation of each of the two emergency steering knobs 44 and 45 switches the two emergency valves 41 and 42 into the emergency steering position, in which hydraulic system 30 is coupled in the sense described hereinabove with hydraulic steering system 19. If first emergency steering knob 44 is actuated, separate hydraulic power unit 31 is activated to the effect that hydraulic oil is pumped into line NL coupled with port L of hydraulic steering system 19. Upon actuation of second emergency steering knob 45, however, separate hydraulic power unit 31 is operated in the opposite delivery direction, so that hydraulic oil is pumped into line NR coupled with port R of hydraulic steering system 19. Since both check valves 24 of hydraulic steering system 19 are blocked, actuation of hydraulic steering cylinder 8 by further hydraulic system 30 in emergency mode is assured.

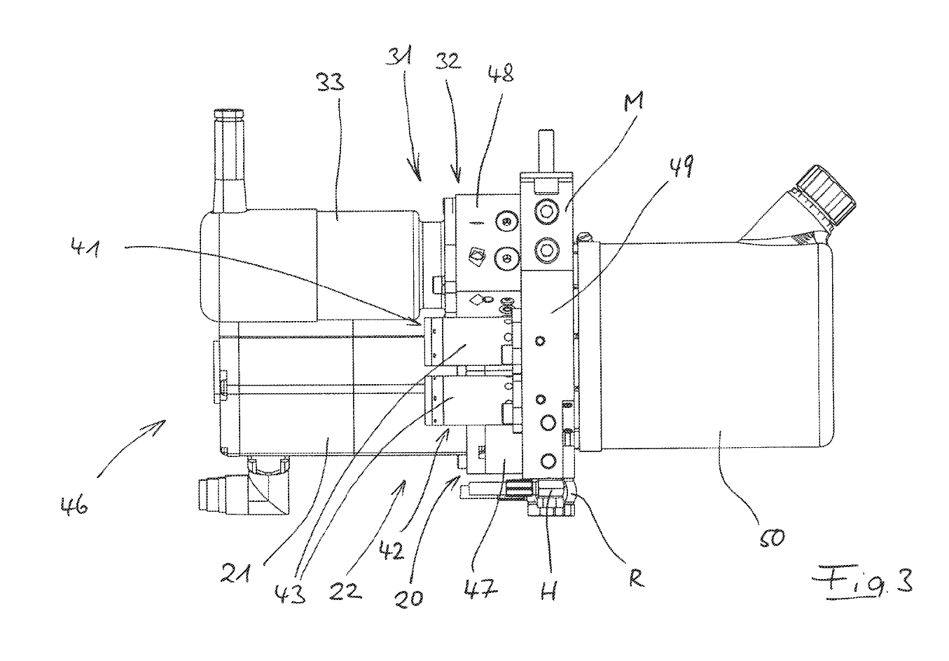

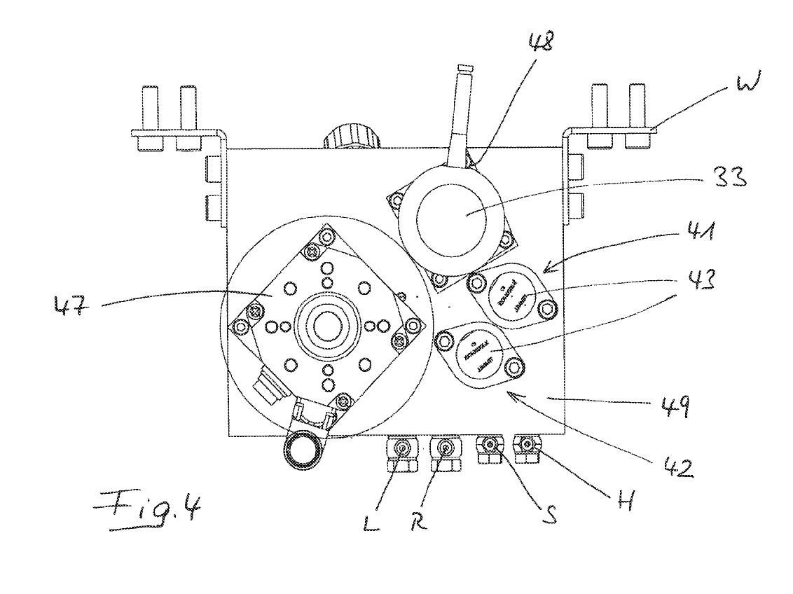

Steering hydraulic power unit 22 and separate hydraulic power unit 31 form a subassembly 46 (see FIGS. 3 and 4). For this purpose, pump block 47 of hydraulic pump 20 of hydraulic steering system 19 and pump block 48 of hydraulic pump 32 of further hydraulic system 30 are disposed on a common connection block 49, although as an obvious alternative the two pumps could be mounted commonly on one single pump block flanged to connection block 49.

Steering hydraulic power unit 22 and separate hydraulic power unit 31 are supplied from a common hydraulic tank 50. Motor 21 of steering hydraulic power unit 22 and motor 33 of separate hydraulic power unit 31 are then disposed adjacent to one another on one side of a connection block 49 and common hydraulic tank 50 is disposed on the other side of connection block 49 in question. The two emergency valves 41 and 42 are also disposed on common connection block 49. Their hydraulic components are mounted in connection block 49; the two associated solenoids 43 are mounted adjacent to pump blocks 47 and 48 on connection block 49. The two mounting brackets M, by means of which the entire subassembly 46 can be mounted at a suitable place in the boat, are obviously bolted onto the connection block.

As a possible improvement of the recreational motor boat described heretofore, the optional arrangement of this second cockpit 51 with a further steering wheel 52 is indicated in FIG. 2. This is designed as a combined electronic/hydraulic steering wheel with an additional conventional helm pump 53, which can be coupled with hydraulic steering system 19.

Instead of the illustrated configuration of the two hydraulic systems, or in other words hydraulic steering system 19 and further hydraulic system 30, with respective hydraulic power units 22 and 31, whose electric motors 21 and 33 are reversible and designed to be controlled by the control unit, each of the hydraulic systems may be designed in other than such a known manner. For example, the action of hydraulic steering cylinder 8 and of hydraulic power consuming unit 29 can be controlled by electrically actuated, adjustable control valves, which are connected via control lines with the respective associated transducer, meaning in particular the steering wheel and the dashboard. The person skilled in the art, in view of the pertinent prior art, will infer this directly from the foregoing explanation of the present invention, and so a separate depiction of this variant is not needed.

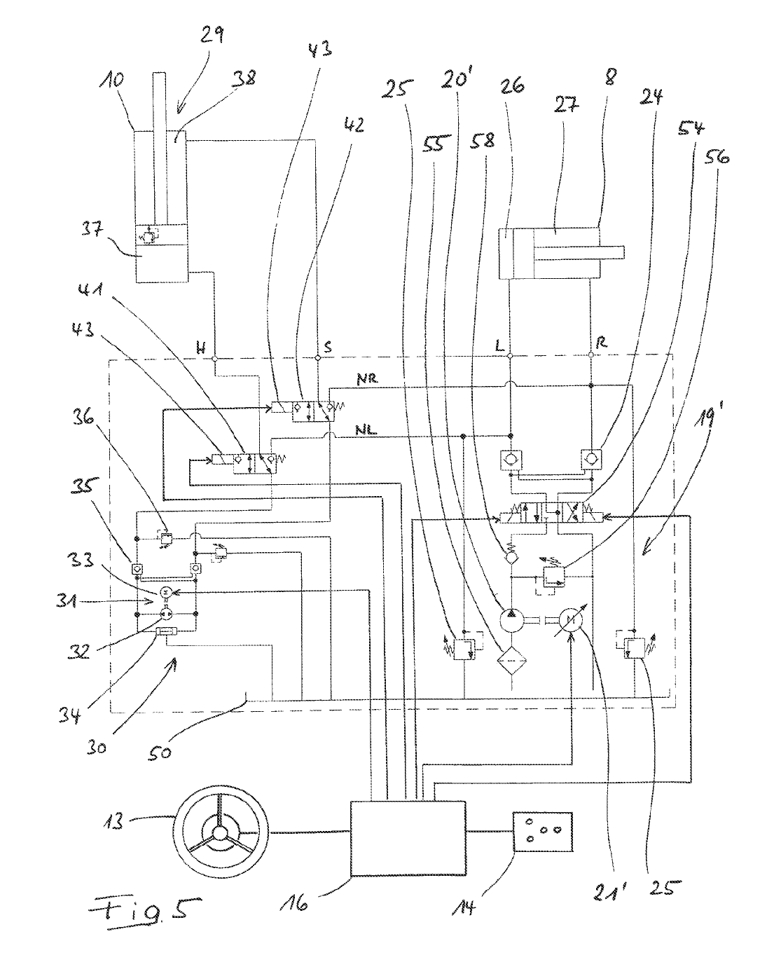

The hydraulic system according to FIG. 5 effectively differs from that according to FIG. 2 merely by a different configuration of hydraulic steering system 19′. And, in fact, according to FIG. 5, no reversible hydraulic power unit is used, but instead a non-reversible steering hydraulic power unit 22′ comprising a hydraulic pump 20′ driven by an electric motor 21′. Accordingly, an electrically actuatable control valve designed as a 4/3-way valve 54 is also provided. Control valve 54 is connected via control lines 57 to control unit 16 in the sense of a steer-by-wire steering concept. By appropriate action by control unit 16, such as excitation of one of the associated solenoids, it can be adjusted from the neutral position (illustrated in FIG. 5), in which hydraulic steering cylinder 8 is blocked by the two check valves 24 (hold position), to a first and second activated position (steer left or steer right positions), in which the pressure port of hydraulic pump 20′ is in communication with port L or port R and adjusts hydraulic steering cylinder 8. Hydraulic steering system 19′ further comprises, as is known as such, a filter 55 disposed upstream from hydraulic pump 20′, a pressure-regulating valve 56 and a check valve 58.

Mounting of the components of hydraulic steering system 19′ can be achieved in a manner corresponding to that explained in the foregoing in connection with FIGS. 3 and 4. In this case also, therefore, especially the two hydraulic power units 22′ and 31 can be combined as a common subassembly, which also comprises all valves mounted in a common connection and valve block.

For the function of emergency steering of the water craft equipped with the hydraulic system according to the circuit diagram shown in FIG. 5 via further hydraulic system 30, which in turn is used in normal operation for actuation of trimming cylinder 10, the foregoing explanations, which do not have to be repeated, are applicable by analogy.

We claim:

1. A water craft comprising:
at least one hull (1);
at least one drive motor (2) having an operative drive connection via a drive train (3) to a drive head (4) comprising a propulsion means (5), wherein the drive head is mounted to pivot laterally relative to the at least one hull around a steering axis (7);
at least one hydraulic steering cylinder (8) that is acted on by a hydraulic steering system (19, 19′) comprising a hydraulic pump (21, 21′) and that is provided for lateral adjustment of the drive head relative to the at least one hull; and
a hydraulic system (30), which comprises a separate hydraulic power unit (31) and is designed to act on a hydraulic power consuming load (29) that is not intended to steer the water craft, can be coupled with the hydraulic steering system (19, 19′) to act on the hydraulic steering cylinder (8).

2. A water craft according to claim 1, wherein the hydraulic system (30) is coupled with the hydraulic steering system (19, 19′) via emergency valves (41, 42).

3. A water craft according to claim 2, wherein the hydraulic power consuming load (29) can be decoupled from the hydraulic system (30) by emergency valves (41, 42).

4. A water craft according to claim 1, wherein the hydraulic system (30) has switching valves that can be manually actuated for influencing the action on the associated hydraulic power consuming load (29).

5. A water craft according to claim 1, wherein the hydraulic steering system (19, 19′) can be switched into a floating position, or the mechanical coupling of the drive head (4) with the hydraulic steering cylinder (8) can be detachable.

6. A water craft according to claim 1, wherein the hydraulic power consuming load (29) is a trimming cylinder (10) for adjusting the drive head (4) around a transverse axis (11) or for adjusting separate trimming devices.

7. A water craft according to claim 1, wherein the hydraulic power consuming load (29) is part of a hydraulic clutch, or of a hydraulic throttle, or of a hydraulic turning gear, or of a hydraulically operated winch.

8. A water craft according to claim 1, wherein the hydraulic pump (21, 21′) of the hydraulic steering system (19, 19′) is part of a steering hydraulic power unit (22, 22′) that comprises an electric motor drive.

9. A water craft according to claim 8, wherein the steering hydraulic power unit (22, 22′) and the hydraulic power unit (31) form a subassembly (46), wherein the hydraulic pump (21, 21′) of the hydraulic steering system (19, 19′) and the hydraulic pump (32) of the hydraulic system (30) are mounted in a common pump block.

10. A water craft according to claim 9, wherein the subassembly (46) comprises a common connection block (49).

11. A water craft according to claim 10, wherein the common connection block (49) and/or the pump block contains an emergency valve unit (41, 42), by means of which the hydraulic power unit (31) can be coupled with the hydraulic steering system (19, 19′).

12. A water craft according to claim 9, wherein the steering hydraulic power unit (22, 22′) and the hydraulic power unit (31) are supplied from a common hydraulic tank (50), wherein the motors (21, 21′; 33) of the steering hydraulic power unit (22, 22′) and of the hydraulic power unit (31) are arranged adjacent to one another on one side of a connection block (49) and/or of a pump block, while the common hydraulic tank (50) is disposed on the other side of the connection block and/or pump block.

13. A water craft according to claim 12, wherein the hydraulic tank (50) is disposed outboard, while the other components are arranged inside the at least one hull (1).

14. A water craft according to claim 1, wherein the hydraulic steering system (19′) comprises at least one electrically activated control valve (54), on which at least one transducer connected to a steering device acts.
